(19) United States
(12) Patent Application Publication
(10) Pub. No.: US 2018/0113997 A1
(43) Pub. Date: Apr. 26, 2018

(54) IMAGE PROCESSING METHOD, IMAGE PROCESSING SYSTEM, RECORDING MEDIUM STORING PROGRAM

(71) Applicant: Panasonic Intellectual Property Corporation of America, Torrance, CA (US)

(72) Inventors: TORU TANIGAWA, Osaka (JP); YUKIE SHODA, Osaka (JP); TETSUJI FUCHIKAMI, Osaka (JP)

(21) Appl. No.: 15/705,586

(22) Filed: Sep. 15, 2017

(30) Foreign Application Priority Data
Oct. 25, 2016 (JP) 2016-209036

(51) Int. Cl. G06F 21/10; G06T 7/11; G06T 5/00; G06K 9/34; G06F 21/84

(52) U.S. Cl. CPC G06F 21/10; G06T 7/11; G06T 5/002; G06F 21/6245; G06F 21/84; G06T 2207/20021; G06K 2209/01; G06K 9/344

(57) ABSTRACT

An image processing method includes: generating a plurality of privacy-protected images by performing obscuring processing, which is privacy-protection image processing, on each of a plurality of images; dividing each of the privacy-protected images into a plurality of areas to generate a plurality of divided images and ordering the divided images belonging to the same privacy-protected image so that the divided images form a continuous image; rearranging an order of the ordered divided images; and outputting, as processed images for annotation, the divided images ordered according to the rearranged order.

### BACKGROUND

### 1. Technical Field

The present disclosure relates to an image processing method, an image processing system, and a recording medium storing a program, the method, the system, and the program performing processing on an image to which an annotation is added.

### 2. Description of the Related Art

For constructing learning data for performing machine learning and so on, annotations, such as labels, are added to image data for recognition of the image data. For example, Japanese Unexamined Patent Application Publication No. 2013-161295 discloses a technology for performing labeling on image data.

Annotations are added to subjects, such as people and objects, included in images. Images in image data to which annotations are added in order to construct learning data for machine learning are large in quantity and various in kind. Thus, in the process of annotation processing, it is necessary to protect privacy related to people, such as people themselves captured on images and the photography locations.

### SUMMARY

One non-limiting and exemplary embodiment provides an image processing method, an image processing system, and a program for enhancing the privacy protection for images in the process of annotation processing.

In one general aspect, the techniques disclosed here feature an image processing method including: generating a plurality of privacy-protected images by performing privacy-protection image processing on each of a plurality of images; dividing each of the privacy-protected images into a plurality of areas to generate a plurality of divided images and ordering the divided images belonging to the same privacy-protected image so that the divided images form a continuous image; rearranging an order of the ordered divided images; and outputting, as processed images for annotation, the divided images ordered according to the rearranged order.

The image processing method and so on according to the present disclosure can improve privacy protection for images in the process of annotation processing.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a schematic configuration of an image processing system according to an embodiment;

FIG. 2 illustrates one example of a pre-processing image;

FIG. 3 illustrates one example of an image obtained by performing obscuring processing on the pre-processing image;

FIG. 4 illustrates one example of images obtained by performing division processing on the image resulting from the obscuring processing;

FIG. 5 is a table illustrating one example of processing parameters of the divided images;

FIG. 6 illustrates one example of processing for mixing and rearranging divided images whose original images are different;

FIG. 7 is a flowchart illustrating one example of a flow of the operation of the image processing system according to the embodiment;

FIG. 8 illustrates one example in which, in an operation of the image processing system according to a first modification of the embodiment, an image processing apparatus divides an image resulting from obscuring processing;

FIG. 9 is a flowchart illustrating one example of a flow of the operation of the image processing system according to a second modification of the embodiment; and

FIG. 10 is a flowchart illustrating one example of a flow of the operation of the image processing system according to a third modification of the embodiment.

### DETAILED DESCRIPTION

The inventors according to the present disclosure, that is, the present inventors, have studied utilization of a technology using a neural network of deep learning and so on in order to improve the accuracies of recognition and detection of subjects, such as people, in images. Recognition of subjects in Deep Learning requires a large amount of image data for learning. In the image data for learning, information including the type, the position, and the area of each subject are added to the subject as annotation information, that is, is annotated thereto. Typically, in the annotation, a person inputs setting of the area of a subject to an image, such as surrounding a subject in an image. Also, a company or the like, such as the creator of image data for learning, is conducting a study on outsourcing annotation processing to an outside contractor. In addition, a study is being conducted on outsourcing the annotation processing to a large number of unspecified contractors by using crowdsourcing.

The present inventors also have studied employing digital image data clipped from digital moving images as a large amount of image data to be annotated. In particular, in order to obtain a large amount of image data, the present inventors have studied employing moving images obtained by a photographic device, such as a security camera or a vehicle-mounted camera, for capturing long-duration moving images. Images obtained from such moving images can include unspecified people and things associated with the people. Thus, the present inventors have raised, as an issue, the necessity of preventing a large number of unspecified contractors from recognizing privacy information regarding subjects, such as features of faces or the like of people in an image, things associated with people in an image, and the photography location thereof. In order to address the issue, the present inventors have found a technology regarding pre image-processing to be performed on an image to which an annotation is added.

### Embodiment

An embodiment that the present inventors disclose based on the above-described knowledge will be described in detail with reference to the accompanying drawings.

The embodiment described below represents a general or specific example. Numerical values, shapes, materials, constituent elements, the arrangement positions and connections of constituent elements, steps, the order of steps, and so on described in the embodiment below are examples and are not intended to limit the present disclosure. Of the constituent elements in the embodiment described below, the constituent elements not set forth in the independent claims that represent the broadest concept will be described as optional constituent elements. In terms of expression, the ordinal numbers, such as first, second, and third, may be added to constituent elements, as appropriate.

An expression including “generally”, such as “generally parallel” or “generally orthogonal”, may be used in the following description of the embodiment. For example, the expression “generally parallel” not only means “being completely parallel” but also means “being substantially parallel”, that is including a difference of, for example, a few percent. This also applies to expressions including “generally”. Each accompanying figure is a schematic diagram and is not necessarily strictly depicted. In addition, in each figure, substantially the same constituent elements are denoted by the same reference numerals, and a redundant description may be omitted or may be briefly given herein.

### [Configuration of Image Processing System]

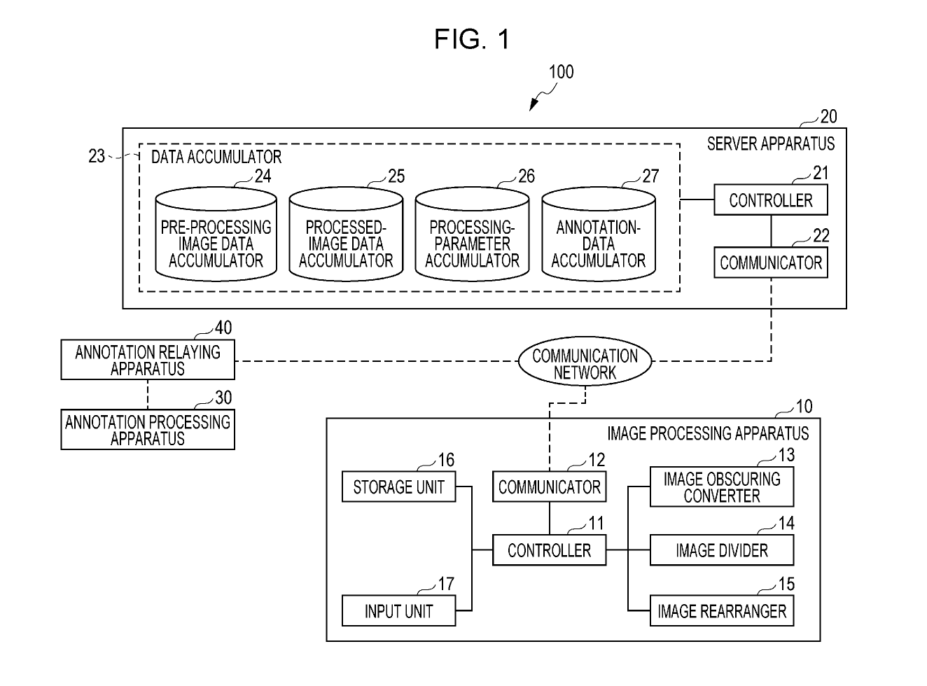

The configuration of an image processing system 100 according to an embodiment will now be described with reference to FIG. 1. FIG. 1 is a block diagram illustrating a schematic configuration of the image processing system 100 according to the embodiment. The image processing system 100 includes an image processing apparatus 10 and a server apparatus 20. The server apparatus 20 is an element in which various types of data are accumulated. The image processing apparatus 10 performs image processing on image data accumulated in the server apparatus 20. The image processing apparatus 10 obtains, from the server apparatus 20, an image to which an annotation is to be added, performs image processing on the image, and accumulates the resulting image in the server apparatus 20.

The image processing apparatus 10 may transmit the processed image data to an annotation processing apparatus 30 of an annotation processor or may transmit the processed image data to an annotation relaying apparatus 40, which relays transmission/reception of image data and annotation information between the annotation processing apparatus 30 and the server apparatus 20. For example, the annotation relaying apparatus 40 executes, for example, issuing a request for annotation processing to the annotation processing apparatus 30 of the annotation processor, obtaining image data to which an annotation is to be added from the server apparatus 20, transmitting the image data to the annotation processing apparatus 30, receiving information regarding the added annotation from the annotation processing apparatus 30, associating the information with the image data, and transmitting the associated information and image data to the server apparatus 20. Communication between the annotation processing apparatus 30 and the server apparatus 20 may be communication that is similar to that between the image processing apparatus 10 and the server apparatus 20 or may be implemented by other wireless communication or wired communication.

Communication between the annotation processing apparatus 30 and the annotation relaying apparatus 40 may be communication that is similar to that between the annotation processing apparatus 30 and the server apparatus 20 or may be implemented by other wireless communication or wired communication. For example, the communication between the annotation processing apparatus 30 and the annotation relaying apparatus 40 may employ a mobile communication standard utilized in a third-generation (3G) mobile communication system, a fourth-generation (4G) mobile communication system, or a mobile communications system based on LTE®.

The server apparatus 20 is configured so as to communicate with the image processing apparatus 10. The server apparatus 20 may be an information processing apparatus, such as a computer. The server apparatus 20 may include one or more server apparatuses or may constitute a cloud system. The server apparatus 20 includes a controller 21 that controls the entire server apparatus 20, a communicator 22 that communicates with the image processing apparatus 10, and a data accumulator 23 that accumulates various types of data therein. The communicator 22 communicates with the image processing apparatus 10 through a communication network, such as the Internet. The communicator 22 may be a communication circuit including a communication interface. For example, the communication between the communicator 22 and the image processing apparatus 10 may be implemented by a wireless local area network (LAN), such as Wi-Fi® (Wireless Fidelity), may be implemented by wired communication using a cable, or may be implemented by other wireless communication or wired communication.

The data accumulator 23 is configured with, for example, a hard disk. The data accumulator 23 includes a pre-processing image data accumulator 24, a processed-image data accumulator 25, a processing-parameter accumulator 26, and an annotation-data accumulator 27. Pre-processing image data, which are image data obtained by various photographic devices, are stored in the pre-processing image data accumulator 24 in conjunction with image identifiers (IDs) thereof. Processed image data, which are obtained by executing image processing on the pre-processing image data in the pre-processing image data accumulator 24, are stored in the processed-image data accumulator 25 in conjunction with image IDs thereof. Information regarding the image processing executed on the pre-processing image data is stored in the processing-parameter accumulator 26 in conjunction with the image IDs of the pre-processing image data and the processed image data. Information regarding annotations added to the processed image data is stored in the annotation-data accumulator 27.

The controller 21 controls the communicator 22 and the data accumulator 23. In response to a request from the image processing apparatus 10, the controller 21 retrieves data from the pre-processing image data accumulator 24, the processing-parameter accumulator 26, and the annotation-data accumulator 27 in the data accumulator 23 and transmits the data via the communicator 22. The controller 21 executes storage of corresponding data in the processed-image data accumulator 25 and the processing-parameter accumulator 26 via the communicator 22, the data being received from the image processing apparatus 10. The controller 21 also executes storage of corresponding data in the annotation-data accumulator 27, the data being received from the annotation processing apparatus 30 of the annotation processor. The controller 21 may execute storage of corresponding data in the annotation-data accumulator 27, the data being received from the annotation relaying apparatus 40.

The image processing apparatus 10 may singularly constitute one apparatus or may be incorporated into an information processing apparatus, such as a computer, or another apparatus. For example, the image processing apparatus 10 may be incorporated into the annotation relaying apparatus 40 or an apparatus including the annotation relaying apparatus 40. The image processing apparatus 10 includes a controller 11, a communicator 12, an image obscuring converter 13, an image divider 14, an image rearranger 15, a storage unit 16, and an input unit 17. The controller 11 controls the entire image processing apparatus 10. The input unit 17 is an element that receives various inputs, such as instructions. The storage unit 16 is an element in which various types of information are stored. The storage unit 16 may be configured with a semiconductor memory or the like or may be configured with a volatile memory, a nonvolatile memory, or the like.

The communicator 12 communicates with the communicator 22 in the server apparatus 20, as described above. The communicator 12 may be a communication circuit including a communication interface. A router that is a communication apparatus for relaying a communication between the communicators 12 and 22 may be provided therebetween. The router may relay a communication between the communicator 12 and the communication network.

Under the control of the controller 11, the image obscuring converter 13 obtains pre-processing image data and its image ID from the pre-processing image data accumulator 24 in the server apparatus 20 and performs obscuring processing on the pre-processing image. This obscuring processing is image processing for privacy protection of subjects in an image. More specifically, the image obscuring converter 13 performs obscuring processing, such as blurring processing, mosaic processing, and pixelization processing. Pixelization refers to reducing the pixel density of an image by augmenting a pixel value of each pixel. The image obscuring converter 13 may obscure an image having low pixel density by increasing the resolution thereof or may obscure an image having high pixel density by reducing the resolution thereof. The image obscuring converter 13 associates the image ID of pre-processing image data with obscured image data resulting from the obscuring processing.

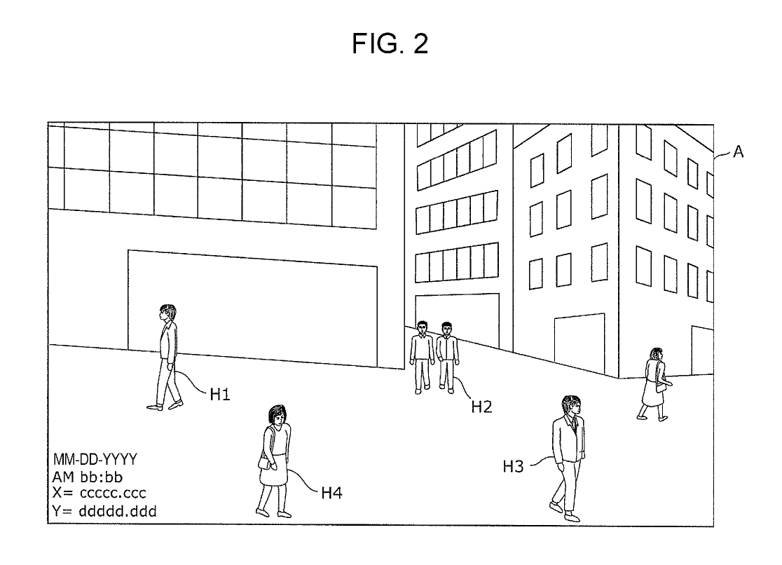

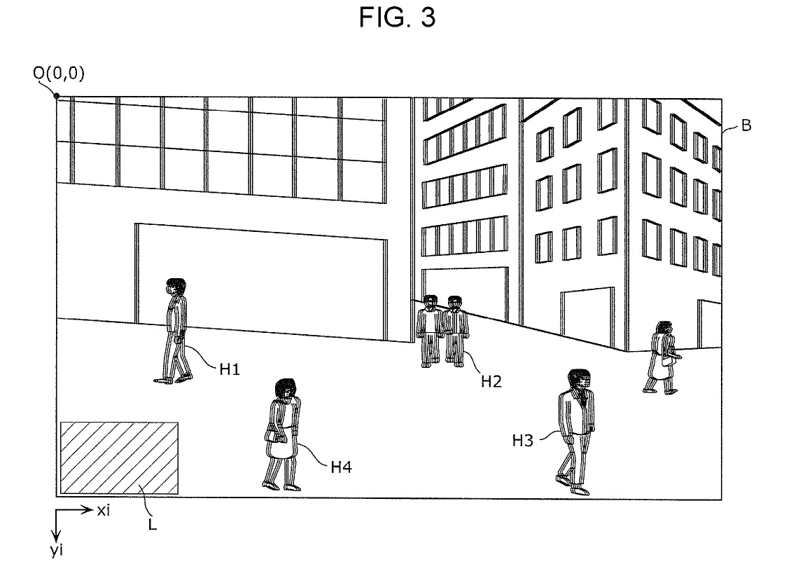

In the present embodiment, for example, by using blurring processing, the image obscuring converter 13 converts an entire pre-processing image A illustrated in FIG. 2 into an obscured image B illustrated in FIG. 3. FIG. 2 illustrates one example of the pre-processing image, and FIG. 3 illustrates one example of an image obtained by performing obscuring processing on the pre-processing image.

Before performing the blurring processing, the image obscuring converter 13 executes character recognition on the pre-processing image A. The image obscuring converter 13 recognizes, for example, characters, symbols, and so on, such as those illustrated at the lower left in FIG. 2, in the pre-processing image A, sets an area including these characters, symbols, and so on as a character area L, and executes deletion processing for blotting out the character area L, as illustrated in FIG. 3. The image obscuring converter 13 may delete the character area L in the pre-processing image A by clipping the character area L. In FIG. 2, the photography date and time of the pre-processing image A and global positioning system (GPS) coordinates of the photography location thereof are illustrated at the position of the character area L. Thus, information that allows identification of subjects in the pre-processing image A is deleted. For example, in the obscuring processing, when blurring processing is performed on the pre-processing image A to a degree that characters, symbols, and so on cannot be recognized, there is a possibility that even the presence/absence of people H1, H2, H3, H4, and so on in the pre-processing image A which have different clarity from that of the characters, symbols, and so on cannot be identified. As described above, by excluding the characters, symbols, and so on from targets of the blurring processing, it is possible to suppress excessive blurring processing on the pre-processing image A. Hence, after executing the deletion processing for blotting out or deleting the characters, symbols, and so on recognized in the pre-processing image A, the image obscuring converter 13 executes blurring processing on the entire pre-processing image A.

The image obscuring converter 13 associates details, the intensity, and so on of the obscuring processing executed on the pre-processing image A with the image ID of the pre-processing image A and transmits the associated information as processing parameters to the processing-parameter accumulator 26 in the server apparatus 20 for storage. Details of the obscuring processing can include obscuring processing involving resolution changing, in addition to the processing, such as blurring processing, mosaic processing, or pixelization processing.

Under the control of the controller 11, the image divider 14 divides an image resulting from the obscuring processing into a plurality of divided images. This makes it difficult to identify elements related to subjects in the image. In addition, the image divider 14 orders the divided images in accordance with the order of arrangement of the divided images that constitute the image resulting from the obscuring processing. That is, the divided images are ordered according to the order of the ordered divided images so as to form a continuous image.

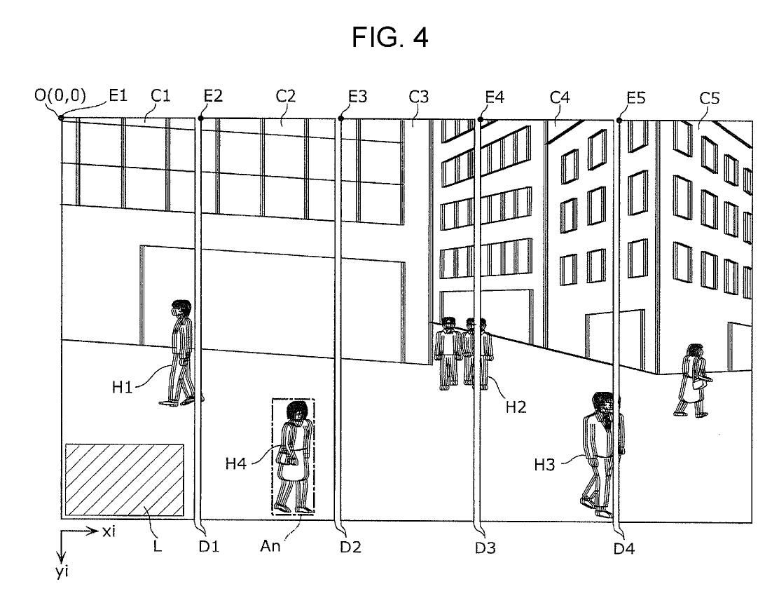

For example, the image divider 14 divides the image B resulting from the obscuring processing into a plurality of images, as illustrated in FIG. 4. FIG. 4 illustrates one example of images obtained by performing division processing on the image resulting from the obscuring processing. In the present embodiment, the image B is divided along four vertical division lines D1, D2, D3, and D4 into horizontally arranged five divided images C1, C2, C3, C4, and C5. Then, ordering is performed in the order of the divided images C1, C2, C3, C4, and C5. The division lines in the image B are not limited to vertical lines and may be lines that extend in any direction. For example, the division lines in the image B may be horizontal lines, may be oblique lines, may be a combination of horizontal lines, vertical lines, and oblique lines, or may be lines that include curved portions. The number of divided images is not limited to five and may be any number.

Before dividing the image B, the image divider 14 sets a coordinate system therefor. Specifically, as illustrated in FIG. 3, the image divider 14 sets an origin O at an upper left corner of the rectangle image B. In addition, the image divider 14 sets, for the image B, an xi axis that extends horizontally from the origin O to the right with positive values and a yi axis that extends vertically down from the origin O with positive values. In the present embodiment, values on the xi axis and the yi axis are each defined by the number of pixels from the origin O. Next, the image divider 14 divides the image B for which the coordinate system is set into the divided images C1 to C5, as illustrated in FIG. 4. The divided images C1 to C5 are rectangular images having borders along the division lines D1 to D4, which are parallel to the yi axis. The image obscuring converter 13 may set the coordinate system for the image B. This allows the image obscuring converter 13 to identify the characters, symbols, and so on in the pre-processing image A and the position and the range of the character area L by using the coordinate system.

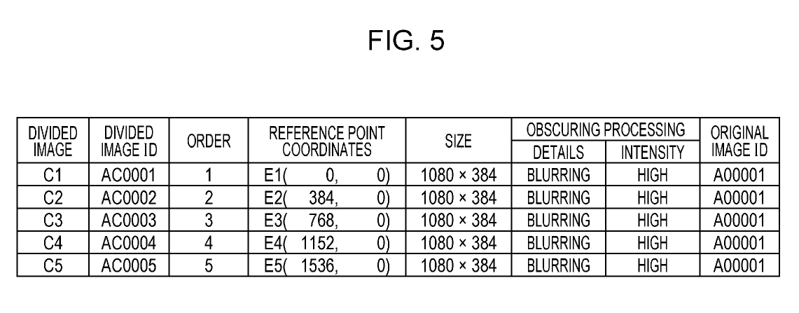

The image divider 14 then sets the upper left corners of the respective divided images C1 to C5 as reference points E1 to E5 and determines the coordinates of each reference point. The image divider 14 also determines the sizes of the respective divided images C1 to C5. In the present embodiment, pixels are used as indicators of the size of each image. The size of the image B is 1080 (height)×1920 (width) pixels. The size of each of the divided images C1 to C5 is 1080 (height)×384 (width) pixels. The coordinates of the reference points of the divided images C1 to C5 and the sizes thereof constitute division position data of the divided images C1 to C5. The division position data of the divided images C1 to C5 may be coordinates indicating the division lines D1 to D4. In addition, the image divider 14 sets new image IDs for the respective divided images C1 to C5. For example, as illustrated in FIG. 5, the image IDs of the divided images C1 to C5, the arrangement order of the divided images C1 to C5, the coordinates of the reference points of the divided images C1 to C5, the sizes thereof, and the details and the intensity of the obscuring processing on the divided images C1 to C5 are associated with the image ID of the image B, which is the original image of the divided images, that is, the pre-processing image A, and the associated data are treated as processing parameters of the divided images C1 to C5. FIG. 5 is a table illustrating one example of the processing parameters of the divided images.

Under the control of the controller 11, the image divider 14 transmits the processing parameters of the divided images C1 to C5 to the processing-parameter accumulator 26 in the server apparatus 20 for storage. Under the control of the controller 11, the image divider 14 may also temporarily store the divided images C1 to C5 in the storage unit 16 in conjunction with the respective image IDs and the image ID of the pre-processing image A and may transmit the divided images C1 to C5 and the image IDs to the processed-image data accumulator 25 in the server apparatus 20 for storage.

Under the control of the controller 11, the image rearranger 15 mixes divided images whose original images are the same and divided images whose original images are different from those divided images and arbitrarily rearranges the mixed divided images, that is, randomly shuffles the divided images. This makes it difficult to identify the location of photography of the image. In addition, the image rearranger 15 newly orders all the divided images in accordance with the arrangement order of all the randomly shuffled divided images.

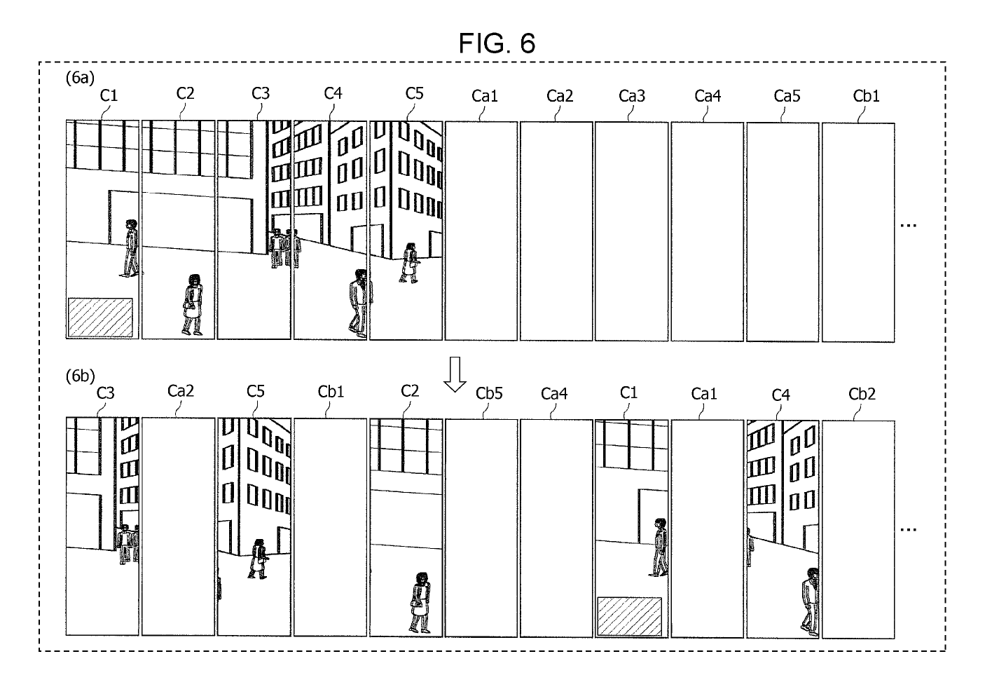

For example, as illustrated in FIG. 6, the image rearranger 15 mixes the divided images C1 to C5 whose original image is the pre-processing image A and divided images Ca1 to Ca5, Cb1 to Cb5, and so on whose original images are images Aa, Ab, and so on that are different from the pre-processing image A and further rearranges the order of the divided images. In this case, for example, the arrangement order among the divided images C1 to C5, the divided images Ca1 to Ca5, and the divided images Cb1 to Cb5 may also be changed, and each of the arrangement order of the divided images C1 to C5, the arrangement order of the divided images Ca1 to Ca5, and the arrangement order of the divided images Cb1 to Cb5 may also be changed. FIG. 6 illustrates one example of processing for mixing and rearranging divided images whose original images are different. In FIG. 6, state (6a) represents a state in which the divided images C1 to C5, Ca1 to Ca5, Cb1 to Cb5, and so on are mixed, and state (6b) represents a state in which the order of the divided images C1 to C5, Ca1 to Ca5, Cb1 to Cb5, and so on is further rearranged. It is desirable that, in state (6b) resulting from the random shuffling, divided images whose original images are the same be ordered so that they are not adjacent to each other. This makes it difficult to recognize associations of divided images whose original images are the same.

In accordance with the arrangement order of the divided images illustrated in state (6b), the image rearranger 15 newly orders the divided images C1 to C5, Ca1 to Ca5, Cb1 to Cb5, and so on. The image rearranger 15 may obtain, from the storage unit 16, the divided images Ca1 to Ca5, Cb1 to Cb5, and so on whose original images are the images Aa, Ab, and so on, the divided images and so on being pre-stored in the storage unit 16, or may obtain the divided images Ca1 to Ca5, Cb1 to Cb5, and so on from the processed-image data accumulator 25, the images and so on being pre-stored in the processed-image data accumulator 25 in the server apparatus 20.

Under the control of the controller 11, the image rearranger 15 transmits a plurality of divided images obtained by mixing the divided images C1 to C5, Ca1 to Ca5, Cb1 to Cb5, and so on and rearranging the order thereof to the processed-image data accumulator 25 in the server apparatus 20 as one divided-image group, in conjunction with the newly set order of the divided images, and the divided-image group is stored in the processed-image data accumulator 25. Thus, the divided-image group includes the divided images, the image IDs, and the order thereof. For example, when divided images are supplied to the annotation processor, the divided images in the divided-image group are supplied on the basis of the divided-image group and in accordance with the above-described order.

The controller 21 in the server apparatus 20 and the constituent elements, namely, the controller 11, the image obscuring converter 13, the image divider 14, and the image rearranger 15, in the image processing apparatus 10 may be implemented by dedicated hardware or may be implemented by executing software program appropriate for the individual constituent elements. In this case, each constituent element may have, for example, a computational processing unit (not illustrated) and a storage unit (not illustrated) in which a control program is stored. Examples of the computational processing unit include a micro processing unit (MPU), a central processing unit (CPU), and so on. One example of the storage unit is a memory. Each constituent element may be constituted by a single element for performing centralized control or may be constituted by a plurality of elements for performing distributed control in cooperation with each other. The software program may be provided as application software via communication through a communication network such as the Internet, communication based on a mobile communication standard, or the like.

Each constituent element may be implemented by a circuit, such as a large-scale integrated (LSI) circuit or a system LSI circuit. A plurality of constituent elements may constitute one circuit as a whole or may constitute respective individual circuits. Each circuit may be a general-purpose circuit or a dedicated circuit.

The system LSI is a super-multifunctional LSI manufactured by integrating a plurality of constituent elements on one chip and is, specifically, a computer system that includes a microprocessor, a read-only memory (ROM), a random-access memory (RAM), and so on. A computer program is stored in the RAM. The microprocessor operates in accordance with the computer program, so that the system LSI realizes its functions. The system LSI and the LSI may each be a field programmable gate array (FPGA) that can be programmed after manufacture of an LSI or may include a reconfigurable processor that allows reconfiguration of connections and settings of circuit cells inside an LSI.

Some or all of the above-described constituent elements may be implemented by a detachable integrated circuit (IC) card or a single independent module. The IC card or the module may be a computer system including a microprocessor, a ROM, a RAM, and so on. The IC card or the module may include the above-described LSI or system LSI. The microprocessor operates in accordance with the computer program, so that the IC card or the module realizes its functions. The IC card or the module may be tamper-proof.

### [Operation of Image Processing System]

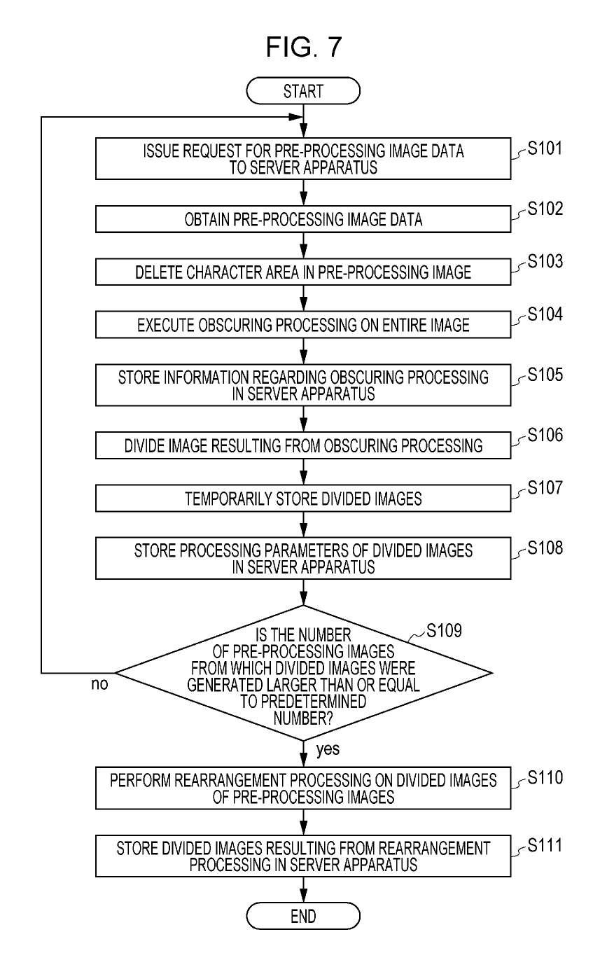

One example of the operation of the image processing system 100 will be described with reference to FIGS. 1 and 7. FIG. 7 is a flowchart illustrating one example of a flow of the operation of the image processing system 100 according to the embodiment. In the present embodiment, the image processing apparatus 10 is operated by a creator of a large amount of learning image data for machine learning of a neural network, such as deep learning. The server apparatus 20 may be operated by the creator or may be operated by a person other than the creator. When the server apparatus 20 is operated by a person other than the creator, it may configure a cloud system.

An apparatus that is independent from the image processing system 100 stores various types of image data in the pre-processing image data accumulator 24 in the server apparatus 20. For example, an image provider that has a contract with the creator sends image data of captured moving images or the like, obtained with a security camera, a vehicle-mounted camera, or the like, to the pre-processing image data accumulator 24. In this case, when the server apparatus 20 configures a cloud system, the image data can be easily stored.

With respect to the operation of the image processing system 100, the controller 11 in the image processing apparatus 10 issues a request for pre-processing image data to the server apparatus 20, in accordance with an instruction that an operator (who may be the above-described creator) of the image processing apparatus 10 inputs to the input unit 17 (step S101).

When the server apparatus 20 receives the request, the controller 21 therein transmits the pre-processing image data stored in the pre-processing image data accumulator 24 and the image ID set for the image data to the image processing apparatus 10. As a result, the controller 11 in the image processing apparatus 10 obtains the pre-processing image data and the image ID (step S102).

The controller 11 in the image processing apparatus 10 causes the image obscuring converter 13 to execute character recognition for detecting characters, symbols, and so on displayed in the pre-processing image. In addition, for example, as illustrated in FIG. 3, the image obscuring converter 13 executes, as one of the obscuring processing, deletion processing for blotting out a character area, which is an area in which the recognized characters and so on exist (step S103). The image obscuring converter 13 may execute deletion processing for deleting the character area by clipping the character area from the image. Also, during the character recognition, the image obscuring converter 13 may detect only privacy-related characters and so on, such as the date and time of image photography and the location information of the photography location, and may delete the area of the detected characters and so on. For deleting the character area, the image obscuring converter 13 may delete the information about the photography date and time and location included in the image data. The deletion processing in this case is one example of privacy-protection image processing.

Next, the controller 11 causes the image obscuring converter 13 to execute obscuring processing for obscuring the entire image resulting from the deletion of the character area (step S104). In the present embodiment, the image obscuring converter 13 executes blurring processing on the entire image, for example, as illustrated in FIG. 3. The image obscuring converter 13 may execute other obscuring processing, such as mosaic processing, pixelization processing, or resolution changing processing, or may execute such obscuring processing in combination with the above-described obscuring processing. The image obscuring converter 13 also uses the image ID of the pre-processing image data for image data resulting from the obscuring processing. The obscuring processing in this case is one example of privacy-protection image processing.

In addition, the controller 11 causes the image obscuring converter 13 to transmit, to the server apparatus 20 as processing parameters, information regarding the details and the intensity of the obscuring processing executed on the image resulting from the deletion of the character area. The server apparatus 20 then receives the processing parameters, and the controller 21 therein stores the processing parameters in the processing-parameter accumulator 26 (step S105).

Thereafter, the controller 11 causes the image divider 14 to divide the image resulting from the obscuring processing into a plurality of images (step S106). For example, as illustrated in FIG. 4, the image divider 14 sets a plurality of division lines for the image resulting from the obscuring processing and divides the image resulting from the obscuring processing into a plurality of images having borders at the division lines. The image divider 14 then sets new image IDs for the divided images, which are images resulting from the division. In addition, the image divider 14 orders the divided images in accordance with the order of arrangement thereof so that the divided images form a continuous image, for example, in accordance with the order of the divided images C1, C2, C3, C4, and C5 illustrated in FIG. 4.

Also, based on a coordinate system that the image obscuring converter 13 or the image divider 14 sets for the pre-division image, the image divider 14 determines the coordinates of reference points and the areas of the images, that is, the sizes of the images, for the divided images. For example, as illustrated in FIG. 4, the image divider 14 sets reference points for the upper left corners of the divided images and determines 1080 (height)×384 (width) pixels as the size of an image. The size of the image before the division is 1080 (height)×1920 (width) pixels.

Next, the controller 11 causes the image divider 14 to temporarily store the divided images in the storage unit 16 in the image processing apparatus 10, in conjunction with the image ID, the order, and the image ID of the pre-processing image, which is the original image of the divided images (step S107).

The controller 11 also causes the image divider 14 to transmit division position data, which includes the image IDs of the respective divided images, the order of the divided images, the coordinates and the sizes of reference points of the divided images, and the image ID of the pre-processing image of the divided images, to the server apparatus 20 as processing parameters. The server apparatus 20 then receives the processing parameters, and the controller 21 therein stores the processing parameters in the processing-parameter accumulator 26 (step S108).

Next, with respect to the divided images stored in the storage unit 16, the controller 11 checks the number of pre-processing images, which are original images of the divided images, that is, the number of pre-processing images from which the divided images were generated. If the number of pre-processing images is larger than or equal to a predetermined number (“yes” in step S109), the process proceeds to a process in step S110. The controller 11 may check, for example, the image IDs of pre-processing images corresponding to the divided images and may determine whether or not the number of image IDs of the pre-processing images is larger than or equal to a predetermined number. If the number of pre-processing images from which the divided images were generated is smaller than the predetermined number (“no” in step S109), the process returns to the process in steps S101 in which the controller 11 issues a request for other pre-processing image data to the server apparatus 20. Then, the processes in steps S102 to S108 are repeated, so that new divided images whose original images are the other pre-processing image are generated and are stored in the storage unit 16. As a result, the number of pre-processing images from which the divided images are generated increases. The predetermined number can be selected from values that are larger than or equal to 2.

In step S110, the controller 11 causes the image rearranger 15 to obtain divided images whose original images are a plurality of pre-processing images stored in the storage unit 16, to mix the obtained divided images, and to execute image rearrangement processing for arbitrarily rearranging the arrangement order of the divided images, that is, for randomly shuffling the divided images, for example, as illustrated in FIG. 6. In this case, the divided images that the image rearranger 15 obtains from the storage unit 16 may be all or some of divided images whose original images are a plurality of pre-processing images. In addition, the image rearranger 15 newly orders all the divided images in accordance with the arrangement order of all the randomly shuffled divided images.

In addition, the controller 11 causes the image rearranger 15 to transmit the group of divided images on which the image rearrangement processing was executed, together with the image IDs of the divided images and the new order thereof, to the server apparatus 20 as processed image data. When the server apparatus 20 then receives the processed image data, the controller 21 therein stores the processed image data in the processed-image data accumulator 25 as image data for annotation (step S111).

With the processed image data obtained by executing the processes in steps S101 to S111 in the manner described above, the image obscuring processing makes it difficult to identify detailed subject features, such as the faces of people in each image, for example, as in the divided images illustrated in FIG. 6. In addition, the image obscuring processing, the division processing, and the rearrangement processing make it difficult to identify the place of image photography and the date and time of the photography. Moreover, the image rearrangement processing makes it difficult to identify the associations between the images.

The processing for adding annotations to the image data stored in the server apparatus 20 is executed as described below. Referring to FIG. 1, the annotation relaying apparatus 40 is operated by a creator of a large amount of learning image data for machine learning. The annotation processing apparatus 30 is operated by a person other than the creator. The operator of the annotation processing apparatus 30 has an annotation-addition processing contract with the creator and adds annotation to images supplied from the creator.

The processed images stored in the processed-image data accumulator 25 in the server apparatus 20 are supplied to the annotation processing apparatus 30 as images to which annotation is to be added. Although, in the present embodiment, the annotation relaying apparatus 40 transmits the processed image data in the server apparatus 20 to the annotation processing apparatus 30, the annotation processing apparatus 30 may directly obtain processed image data from the server apparatus 20.

The images supplied to the annotation processing apparatus 30 are based on a divided-image group including divided images whose original images are pre-processing images and on which the image rearrangement processing was performed as described above. images in the same divided-image group, that is, in the same processed image group, are sequentially supplied to the annotation processing apparatus 30 in accordance with the arrangement order resulting from the image rearrangement processing. Images in one processed image group may be supplied to a plurality of annotation processing apparatuses 30. With respect to the processed images that are sequentially supplied, the operator of the annotation processing apparatus 30 identifies a subject area, for example, by surrounding a subject, such as the person H4, with a frame An, as illustrated in the divided image C2 in FIG. 4. As a result, annotations are added to the processed images. Then, annotation information including the types of subject and information indicating the areas of subjects, the positions thereof, and so on is associated with the image IDs of the processed images, and the annotation information associated therewith is transmitted from the annotation processing apparatus 30 to the server apparatus 20 via the annotation relaying apparatus 40 and is stored in the annotation-data accumulator 27 in the server apparatus 20. For example, each subject may be not only a human but also animal or may be a vehicle, such as a two-wheeled vehicle or a four-wheeled vehicle, a vehicle that travels on a track, such as a railroad, boats and ships, or an aerial vehicle, such as a drone. For example, when the subject of interest is a human, the types of subject include a gender, age group, and so on; when the subject of interest is animal, the types of subject include the type of animal; and when the subject of interest is a vehicle, the types of subject include a vehicle type and so on. In addition, when the subject of interest is a vehicle that travels on a track, the types of subject include the type of vehicle, a route name, and so on; when the subject of interest is a boat or ship, the types of subject include the type of boat or ship; and when the subject of interest is an aerial vehicle, the types of subject includes the type of aerial vehicle.

The supply of the processed images to the annotation processing apparatus 30 may be executed so that a plurality of processed images do not exist in the annotation processing apparatus 30 at the same time or may be executed so that a plurality of processed images are permitted to exist in the annotation processing apparatus 30 at the same time. However, it is desirable that the processed images be supplied so that associations therebetween are not identified.

In addition, by using the processing parameters stored in the processing-parameter accumulator 26 in the server apparatus 20, the creator can deactivate the obscuring processing on the processed image data stored in the processed-image data accumulator 25 and can further associate the processed image data with the annotation information stored in the annotation-data accumulator 27. Thus, the processed image data can be used as learning image data for machine learning.

### [First Modification of Operation of Image Processing System]

The description below will be given of a first modification of the operation of the image processing system 100. When the image processing apparatus 10 divides an image resulting from the obscuring processing into a plurality of images, the division lines set for the image resulting from the obscuring processing in the embodiment described above correspond to the borders of the divided images, and thus the divided images do not overlap each other. However, in this modification, the divided images overlap each other, which is a difference from the embodiment. Differences from the embodiment will be mainly described below with respect to this modification.

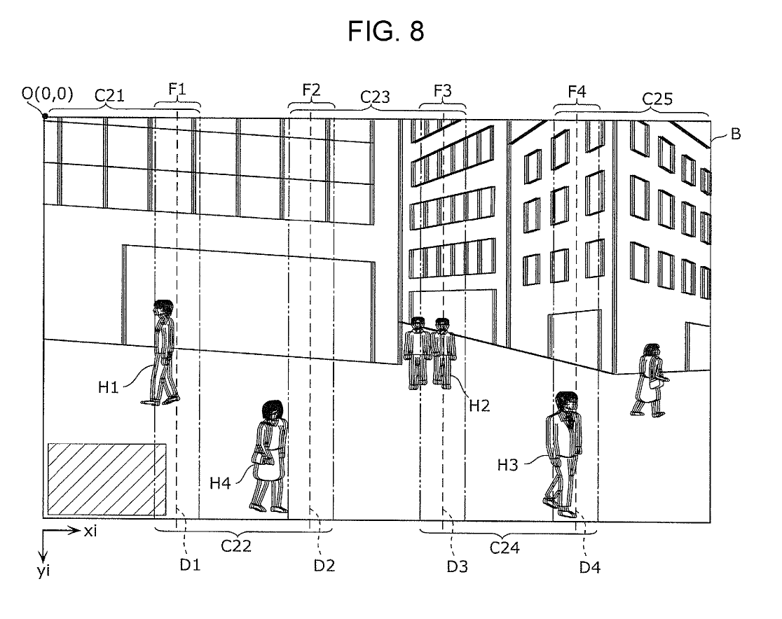

Referring to FIGS. 1 and 8, the image divider 14 in the image processing apparatus 10 in the image processing system 100 sets division lines D1 to D4 for an image B (see FIG. 8) resulting from the obscuring processing in step S104 illustrated in FIG. 7, as in the embodiment. FIG. 8 illustrates one example in which, in the operation of the image processing system 100 according to the first modification of the embodiment, the image processing apparatus 10 divides the image B resulting from the obscuring processing.

The image divider 14 sets horizontally arranged five divided images C21, C22, C23, C24, and C25 so that they extend beyond corresponding division lines D1 to D4. Specifically, the divided image C21 has one end at a position beyond the division line D1. The divided image C22 has two opposite ends at positions beyond the division lines D1 and D2. The divided image C23 has two opposite ends at positions beyond the division lines D2 and D3. The divided image C24 has two opposite ends at positions beyond the division lines D3 and D4. The divided image C25 has one end at a position beyond the division line D4. Hence, the divided images C21 and C22 overlap each other in an overlap area F1 along the division line D1, the divided images C22 and C23 overlap each other in an overlap area F2 along the division line D2. The divided images C23 and C24 overlap each other in an overlap area F3 along the division line D3. The divided images C24 and C25 overlap each other in an overlap area F4 along the division line D4.

The image divider 14 calculates the coordinates of reference points of the divided images C21 to C25 and the sizes thereof and further orders the divided images C21 to C25. The image divider 14 then associates the coordinates of the reference points, the sizes, and the order of the divided images C21 to C25 with the image IDs set for the divided images C21 to C25 and the image ID of the pre-processing image, which is the original image thereof, and stores the associated information in the processing-parameter accumulator 26 in the server apparatus 20 as processing parameters. Other operations of the image processing apparatus 10 are substantially the same as those in the embodiment.

As a result of providing the overlap areas F1 to F4 in the divided images C21 to C25, for example, each of the people H1, H2, and H3 included in the people H1 to H4 and located on the corresponding division lines D1, D3, and D4 is entirely or generally entirely displayed in at least one of two divided images including the corresponding overlap area F1, F3, or F4, as illustrated in FIG. 8. When annotations are added to processed images based on the divided images C21 to C25, the annotation processor executes annotation addition processing in which each of the people H1 to H3 in the corresponding divided images is processed as one individual.

Now, when a description is given of the person H2 by way of example, the area and the coordinates of an annotation added to the person H2 can be determined based on the processing parameters and the annotation information of the divided image C23, that is, the processed image C23. The coordinates are based on a coordinate system set for the pre-processing image or the pre-division image. Also, the area and the coordinates of an annotation added to the person H2 can be determined based on the processing parameters and the annotation information of the processed image C24. The areas of the two annotations mostly overlap each other. As a result, the annotations added to the person H2 in the processed images C23 and C24 can be identified as being annotations for the same person. Hence, the accuracy of annotation increases.

On the other hand, as illustrated in FIG. 4, with respect to the divided images C1 to C5, that is, the processed images C1 to C5, having borders along the division lines D1 to D4, annotation addition processing is performed regarding the person H2 in each of the processed image C3 and C4 as one person. In this case, since the areas of the two annotations for the person H2 in the processed images C3 and C4 do not overlap each other, there is a high possibility that these annotations are treated as annotations for two people. Hence, the accuracy of annotation decreases.

Thus, provision of overlap areas in divided images in the manner described above increases the accuracy of annotation for a subject displayed in the vicinity of a border between the divided images.

### [Second Modification of Operation of Image Processing System]

The following description will be given of a second modification of the operation of the image processing system 100. The operation of the image processing system 100 according to the second modification differs from that of the above-described embodiment in that, after the annotation processor adds annotations to processed images on which image processing as illustrated in FIG. 7 is executed, image obscuring processing, which is processing for reducing the degree of obscuration, is executed to generate processed images. In this modification, differences from the embodiment and the first modification will be mainly described below. The intensity of the degree of obscuration can be determined using various parameters according to a scheme for the obscuring processing. When blurring processing is executed as the obscuring processing, for example, there is a scheme using a smoothing filter, a median filter, a maximum filter, a minimum filter, or the like. In order to determine the luminance value of a pixel of interest, each filter uses the luminance values of pixels in the vicinity of the pixel of interest. In this case, the range of pixels to be used corresponds to a parameter for the degree of obscuration. The larger the range of pixels to be used is, that is, the larger the parameter is, the greater the degree of obscuration is. Hence, by setting the parameter, it is possible to set the intensity of the degree of obscuration of an image.

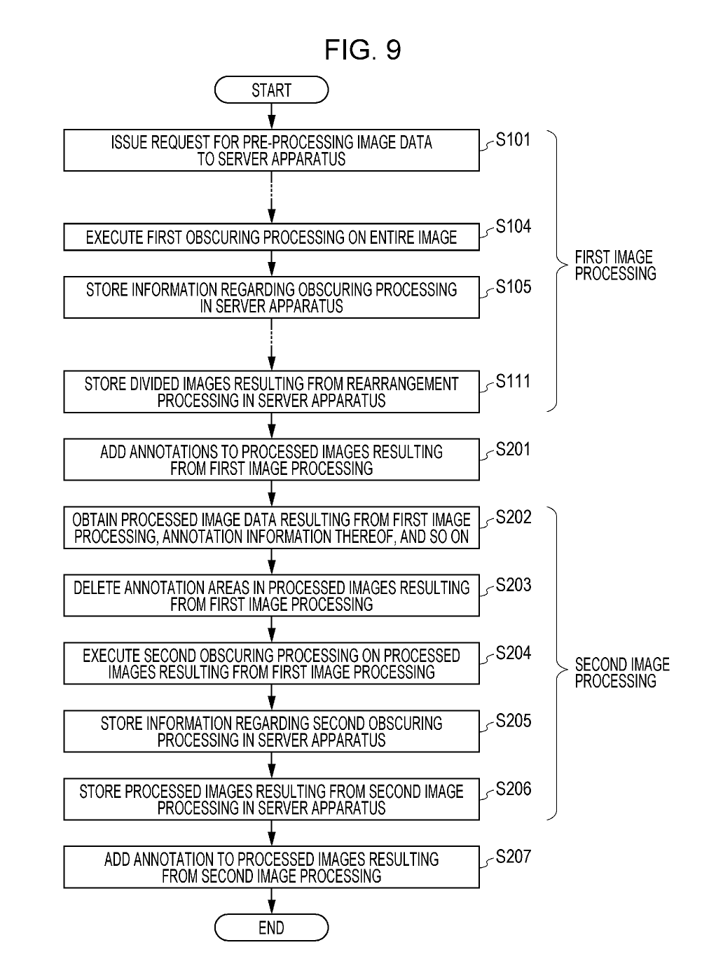

FIG. 9 is a flowchart illustrating one example of a flow of the operation of the image processing system 100 according to the second modification of the embodiment. Referring to FIGS. 1 and 9, by executing the processes in steps S101 to S111 as in the embodiment described above, the image processing apparatus 10 in the image processing system 100 executes first image processing on a pre-processing image obtained from the server apparatus 20 to thereby generate processed images. In step S104, the image obscuring converter 13 in the image processing apparatus 10 executes image obscuring processing using a relatively high degree of obscuration, that is, executes first obscuring processing. For example, of the people H1 to H4 illustrated in FIG. 2, the people H1, H3, and H4 are present near a photographic device of the image and are clearly displayed in large size, but the person H2 is present away from the photographic device and is less clearly displayed in smaller size. The relatively high degree of obscuration refers to the degree of obscuration at which the people H1, H3, and H4 in the image resulting from the first obscuring processing can be identified as being humans by the annotation processor, but the person H2 cannot be identified as a human by the annotation processor. This relatively high degree of obscuration is not limited to the above-described degree of obscuration, may be any degree of obscuration, and may be set as appropriate. The first obscuring processing using the relatively high degree of obscuration is one example of privacy-protection image processing using a first intensity.

Next, annotation addition processing on processed images resulting from the first image processing is executed via the annotation processing apparatus 30 of the annotation processor (step S201). Annotation information added to the processed images is then stored in the annotation-data accumulator 27 in the server apparatus 20. In this case, for example, annotations are added to the people H1, H3, and H4 illustrated in FIG. 2, but no annotation is added to the person H2. Hence, annotations are added to some of the subjects.

Thereafter, the controller 11 in the image processing apparatus 10 issues, to the server apparatus 20, a request for the processed image data on which the first image processing was performed and to which the annotations are added, processing parameters of the processed images, and annotation information of the processed images. The controller 21 in the server apparatus 20 transmits, to the image processing apparatus 10, corresponding processed images, processing parameters, and annotation information stored in the processed-image data accumulator 25, the processing-parameter accumulator 26, and the annotation-data accumulator 27. Thus, the image processing apparatus 10 obtains the requested data (step S202).

The controller 11 in the image processing apparatus 10 causes the image obscuring converter 13 to identify the ranges and the positions of the respective areas to which the annotations are added in the processed images. In addition, the image obscuring converter 13 executes obscuring processing on the identified annotation areas by using a degree of obscuration that is higher than or equal to that in the first obscuring processing. Specifically, the image obscuring converter 13 executes deletion processing for blotting out the identified annotation areas (step S203). For example, the annotation areas for the people H1, H3, and H4 illustrated in FIG. 2 are deleted. Also, in the above-described processing, the image obscuring converter 13 may execute processing for deleting each annotation area by clipping it from the image. Alternatively, based on the processing parameters, the image obscuring converter 13 may identify the details of the first obscuring processing and determine the details and the intensity of the obscuring processing. Herein, the obscuring processing using the degree of obscuration that is higher than or equal to the first obscuring processing is one example of privacy-protection image processing by using a second intensity.

After step S203, based on the processing parameters, the controller 11 causes the image obscuring converter 13 to identify the details of the first obscuring processing executed on the processed images. In addition, based on the identified information, the image obscuring converter 13 deactivates the first obscuring processing on the processed images and executes other obscuring processing using a relatively low degree of obscuration, which is lower than that of the first obscuring processing, that is, second obscuring processing, on the resulting processed images (step S204). In this case, since the first obscuring processing on the areas on which the first obscuring processing was executed is deactivated in the processed images, the obscuring processing for the annotation areas on which the obscuring processing was executed in step S203 is maintained. Thus, the degree of obscuration of the obscuring processing in step S203 may be equivalent to that of the first obscuring processing. Although the second obscuring processing is executed on the areas on which the first obscuring processing was deactivated, the second obscuring processing may be executed on the entire processed images. In this case, the obscuring processing on the annotation areas is also maintained. Herein, the second obscuring processing using the degree of obscuration that is lower than that of the first obscuring processing is one example of privacy-protection image processing by using a third intensity.

The relatively low degree of obscuration is, for example, a degree of obscuration with which the annotation processor can determine that the person H2 illustrated in FIG. 2 is a human. This relatively low degree of obscuration is not limited to the above-described degree of obscuration, may be any degree of obscuration, and may be set as appropriate. For example, the image obscuring converter 13 may also change or convert the first obscuring processing executed on the processed images into the second obscuring processing using the relatively low degree of obscuration. As a result of the above-described second obscuring processing, processed images on which the second image processing was executed are generated.

In addition, the controller 11 causes the image obscuring converter 13 to store information regarding the details and intensity of the second obscuring processing in the processing-parameter accumulator 26 in the server apparatus 20 as processing parameters (step S205). The controller 11 also causes the image obscuring converter 13 to store the processed image resulting from the second image processing in the processed-image data accumulator 25 in the server apparatus 20 as image data for annotation (step S206).

Next, annotation addition processing on the processed images resulting from the second image processing is executed via the annotation processing apparatus 30 of the annotation processor (step S207). Then, annotation information added to the processed images is stored in the annotation-data accumulator 27 in the server apparatus 20. In this case, for example, an annotation is added to the person H2 illustrated in FIG. 2. As a result, annotations are added to all the subjects. In this modification, at least one of the division processing on the image resulting from the obscuring processing and the rearrangement processing on the divided images, as in the processes in steps S106 to S110 in the embodiment, may be omitted.

### [Third Modification of Operation of Image Processing System]

The description below will be given of a third modification of the operation of the image processing system 100. In the operation of the image processing system 100 according to the third modification, image processing is executed twice on some of a plurality of pre-processing images to be subjected to the image processing, as in the second modification. Then, image processing is further executed once on the remaining pre-processing images by using obscuring processing based on the obscuring processing executed on some of the pre-processing images. Differences from the embodiment and the first and second modifications will be mainly described with respect to this modification.

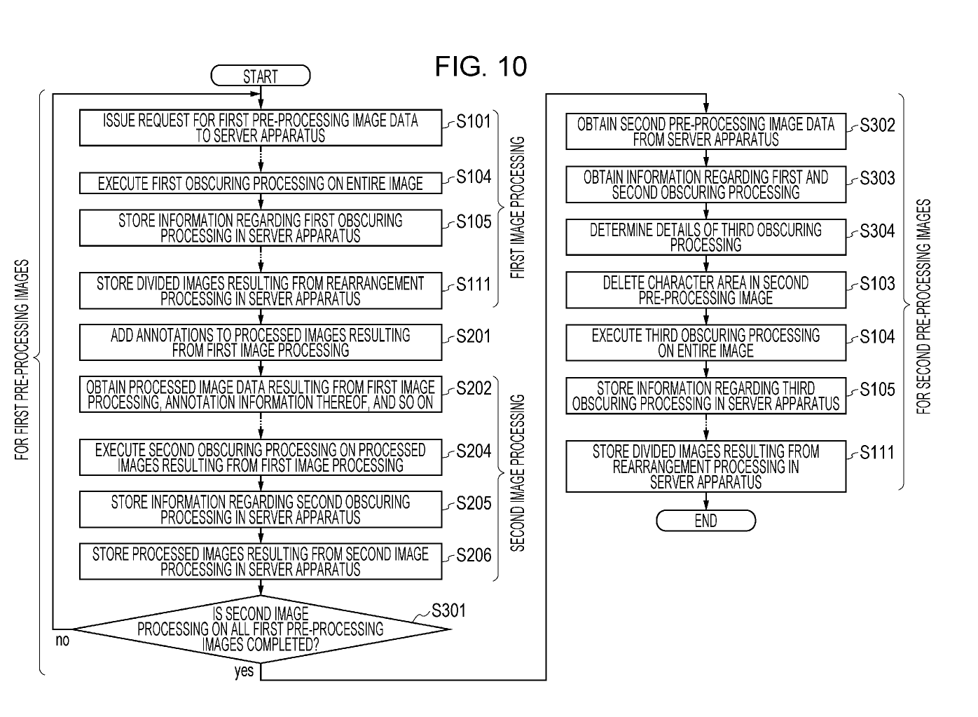

FIG. 10 is a flowchart illustrating one example of a flow of the operation of the image processing system 100 according to the third modification of the embodiment. Referring to FIGS. 1 and 10, by executing processes in steps S101 to S111 and S201 to S206, the image processing apparatus 10 in the image processing system 100 executes image processing twice on first pre-processing images obtained from the pre-processing image data accumulator 24 in the server apparatus 20 to thereby generate processed images, as in the second modification. The annotation processing (which is the process in steps S207 (see FIG. 9) described in the second modification) on the processed images resulting from the second image processing may be executed at any timing after step S206, and thus a description thereof is not given herein.

The pre-processing images stored in the pre-processing image data accumulator 24 have been ordered with numbers or the like given thereto. The first pre-processing images are some pre-processing images selected from pre-processing images to be subjected to the image processing, and the remaining pre-processing images excluding the first pre-processing images from the pre-processing images to be subjected to the image processing are second pre-processing images. In this modification, the first pre-processing images are remaining pre-processing images resulting from extracting one pre-processing image per two pre-processing images of pre-processing images to be subjected to the image processing. Thus, each of the first pre-processing images and the second pre-processing images has every other number.

The selection method for the first pre-processing images is not limited to the above-described method, and may be any method. For example, the number of first pre-processing images to be constituted may be equal to the number of second pre-processing images, as described above, or may be different therefrom. The first pre-processing images may also be pre-processing images selected so as to have continuous numbers, for example, may be pre-processing images that remain after extracting one pre-processing image per three or more pre-processing images. Alternatively, the first pre-processing images may be selected so that both the first pre-processing images and the second pre-processing images have continuous numbers, for example, may be pre-processing images that remain after extracting two pre-processing images with continuous numbers per four pre-processing images. Also, the first pre-processing images may be selected so that only the second pre-processing images have continuous numbers. In the image processing of the second pre-processing images, since the information regarding the obscuring processing on the first pre-processing images is used, it is desirable that a number of images which is larger than or equal to the number of second pre-processing images be constituted as the first pre-processing images.

After S206, if the controller 11 in the image processing apparatus 10 determines that the second image processing using the second obscuring processing on all the first pre-processing images is completed (“yes” in step S301), the process proceeds to a process in steps S302 in order to execute image processing on the second pre-processing images. On the other hand, upon determining that the second image processing on all the first pre-processing images is not completed (“no” in step S301), the process returns to the process in steps S101 in which the controller 11 executes the image processing on an unprocessed first pre-processing image. Alternatively, if there is a first pre-processing image on which only the first image processing is completed, the controller 11 returns to the process in step S202.

In step S302, the controller 11 in the image processing apparatus 10 issues a request for second pre-processing image data to the server apparatus 20. The controller 11 then obtains the second pre-processing image data stored in the pre-processing image data accumulator 24 and transmitted from the controller 21 in the server apparatus 20.

Next, in step S303, the controller 11 in the image processing apparatus 10 issues, to the server apparatus 20, a request for information regarding the details of the first obscuring processing and the second obscuring processing executed on the first pre-processing images previous to and subsequent to the obtained second pre-processing image. The controller 11 then obtains the information stored in the processing-parameter accumulator 26 in the server apparatus 20 and transmitted by the controller 21. For example, the number of the second pre-processing image is denoted by n, and the numbers of the first pre-processing images previous to and subsequent to the second pre-processing image are denoted by n−1 and n+1.

Next, the controller 11 in the image processing apparatus 10 causes the image obscuring converter 13 to determine the details of third obscuring processing, which is obscuring processing to be executed on the second pre-processing image with number n, based on the details of the first obscuring processing and the second obscuring processing on the first pre-processing images with two numbers n−1 and n+1 (step S304). In this modification, a degree of obscuration indicating the intensity of the third obscuring processing is determined. The degree of obscuration for the third obscuring processing is selected from values between two degrees of obscuration of the first obscuring processing on the first pre-processing images with numbers n−1 and n+1 and two degrees of obscurations of the second obscuring processing thereon. The average value, median, or the like of the degrees of obscuration of the first obscuring processing and the two degrees of obscuration of the second obscuring processing is used as the value to be selected. The average value may be an arithmetic mean, geometric mean, harmonic mean, weighted mean, or the like.

The details of the first obscuring processing and the second obscuring processing on the first pre-processing images with numbers close to number n may be used to determine the details of the third obscuring processing on the second pre-processing image with number n. The number of first pre-processing images used to determine the details of the third obscuring processing is not limited to two and may be three or more. For example, not only the first pre-processing images with numbers n−1 and n+1 but also the first pre-processing images with numbers close to number n, such as numbers n−3 and n+3, may be used to determine the details of the third obscuring processing on the second pre-processing image with number n. Also, instead of the first pre-processing images with numbers n−1 and n+1 previous to and subsequent to the second pre-processing image with number n, only the first pre-processing images with previous numbers, such as numbers n−3 and n−1, or only the first pre-processing images with subsequent numbers, such as numbers n+1 and n+3, may be used to determine the details of the third obscuring processing on the second pre-processing image with number n.

After determining the details of the third obscuring processing, the controller 11 in the image processing apparatus 10 generates processed images resulting from the image processing using the third obscuring processing, by executing the processes in steps S103 to S111, as in the embodiment. Then, annotation addition processing is executed on the generated processed images.

As a result of the processing described above, annotation addition processing is executed twice on the same image with respect to the first pre-processing images, and annotation addition processing is executed once on the same image with respect to the second pre-processing images. Hence, the number of times the annotation addition processing is executed decreases, compared with a case in which the annotation addition processing is executed twice on all images in the manner in the second modification. In this modification, at least one of the division processing on the image resulting from the obscuring processing and the rearrangement processing on the divided images, as in the processes in steps S106 to S110 in the embodiment, may be omitted.

### [Advantages, Etc.]

As described above, the image processing system 100 according to the embodiment includes the image obscuring converter 13 and the image divider 14. The image obscuring converter 13 serves as an image converter that generates a privacy-protected image by performing obscuring processing, which is privacy-protection image processing, on an image. The image divider 14 generates a plurality of divided images by dividing the privacy-protected image into a plurality of areas. The image divider 14 orders the divided images that form the privacy-protected image. The image processing system 100 further includes the image rearranger 15 that rearranges the order of the ordered divided images and that newly orders the divided images according to the rearranged order.

In the above-described configuration, since the privacy-protected image of each image is an image that has been subjected to the obscuring processing, which is privacy-protection image processing, it is difficult to identify subjects' privacy information, such as features of subjects, in each privacy-protected image. In addition, since each privacy-protected image is divided, it is difficult to identify the subjects' privacy information, such as the photography location of the image. Additionally, since the order of divided images is rearranged, it is more difficult to identify the subjects' privacy information, such as the photography location of the image.

Also, the image processing system 100 according to the second modification of the embodiment includes the image obscuring converter 13 and the controller 11. The image obscuring converter 13 serves as a first image converter that generates a first privacy-protected image by performing the first obscuring processing, which is privacy-protection image processing using a first intensity, on an image. The controller 11 serves as a first output that outputs the first privacy-protected image as an image for annotation. The image obscuring converter 13 also functions as a second image converter that generates a second privacy-protected image by performing deletion processing, which is privacy-protection image processing using a second intensity that is higher than or equal to the first intensity, on an area to which an annotation is added and that is included in the first privacy-protected image to which the annotation is added. In addition, the image obscuring converter 13 functions as a third image converter that generates a third privacy-protected image by deactivating the first obscuring processing, performed by the first image converter, on the second privacy-protected image and performing the second obscuring processing, which is privacy-protection image processing using a third intensity lower than the first intensity. The controller 11 also functions as a second output that outputs the third privacy-protected image as an image for annotation.

In the above-described configuration, since an image is subjected to the first obscuring processing, the second obscuring processing, and the deletion processing, which are privacy-protection image processing, it is difficult to identify subject's privacy information, such as subject's features, in the image. In addition, the first privacy-protected image resulting from the first obscuring processing allows an annotation to be added to a clear subject in a pre-processing image, and also makes it difficult to identify the subject's features. Additionally, it is possible to make it difficult to add an annotation to an unclear subject in the pre-processing image. The second privacy-protected image resulting from the deletion processing maintains or increases the difficulty of identifying features of a subject to which an annotation is added in the first privacy-protected images. The third privacy-protected image resulting from the second obscuring processing allows an annotation to be added to a subject to which adding an annotation was difficult in the first privacy-protected image, but makes it difficult to identify the subject's features. Identifying features of a subject to which an annotation is added in the first privacy-protected image remains difficult. This can make it difficult to identify the privacy information of all subjects in an image, while making it possible to add annotations to all the subjects.

In the image processing system 100 according to the third modification of the embodiment, the image obscuring converter 13 obtains a fourth intensity for the third obscuring processing, which is privacy-protection image processing, based on the first intensity for the first obscuring processing and the third intensity for the second obscuring processing. In addition, the image obscuring converter 13 executes the third obscuring processing on an image on which the image processing has not been executed. The controller 11 then executes division processing, divided-image rearrangement processing, and so on on the image resulting from the third obscuring processing.

In the above-described configuration, some of a plurality of images to be subjected to the image processing are subjected to the image processing using the first obscuring processing and the second obscuring processing and are subjected to annotation processing twice, that is, between the first obscuring processing and the second obscuring processing and after the second obscuring processing. Other images to be subjected to the image processing are subjected to the image processing using the third obscuring processing and are subjected to annotation processing once after the third obscuring processing. Hence, compared with a case in which annotation processing is executed twice on all images, the number of times the annotation processing is executed decreases, thus making it possible to simplify and expedite the image processing and the annotation processing.

Also, an image processing method according to the embodiment includes: generating a plurality of privacy-protected images by performing obscuring processing, which is privacy-protection image processing, on each of a plurality of images; dividing each of the privacy-protected images into a plurality of areas to generate a plurality of divided images and ordering the divided images belonging to the same privacy-protected image so that the divided images form a continuous image; rearranging an order of the ordered divided images; and outputting, as processed images for annotation, the divided images ordered according to the rearranged order. The above-described method provides an advantage that is the same as or similar to that of the image processing system 100 according to the embodiment.

An image processing method according to the second modification of the embodiment further includes: obtaining, as first processed images, the processed images to which an annotation is added, after the outputting of the divided images; performing deletion processing on an area that is included in the first processed images and to which the annotation is added, the deletion processing being privacy-protection image processing using a second intensity higher than or equal to a first intensity of first obscuring processing that has been performed; performing, on the first processed images resulting from the deletion processing, second obscuring processing using a third intensity lower than the first intensity after deactivating the first obscuring processing; and outputting, as second processed images for annotation, the first processed images resulting from the second obscuring processing. The above-described method provides an advantage that is the same as or similar to that of the image processing system 100 according to the second modification.

An image processing method according to the second modification of the embodiment includes generating a first privacy-protected image by performing first obscuring processing using a first intensity on an image; outputting the first privacy-protected image as an image for annotation; obtaining the first privacy-protected image to which an annotation is added, after the outputting of the first privacy-protected image; generating a second privacy-protected image by performing, on an area to which the annotation is added and that is included in the first privacy-protected image to which the annotation is added, deletion processing using a second intensity higher than or equal to the first intensity; generating a third privacy-protected image by performing, on the second privacy-protected image, second obscuring processing using a third intensity lower than the first intensity after deactivating the first obscuring processing; and outputting the third privacy-protected image as an image for annotation. The above-described method also provides an advantage that is the same as or similar to that of the image processing system 100 according to the second modification.

An image processing method according to the third modification of embodiment further includes: obtaining a fourth intensity of privacy-protection image processing, based on the first intensity of the first obscuring processing and the third intensity of the second obscuring processing; performing third obscuring processing, which is privacy-protection image processing using the fourth intensity, on an unprocessed image that is included in the plurality of images and on which the privacy-protection image processing is not executed; dividing the unprocessed image resulting from the third obscuring processing into a plurality of areas to generate a plurality of divided images and ordering the divided images belonging to the same privacy-protected image so that the divided images form a continuous image; rearranging an order of the ordered divided images; and outputting, as processed images for annotation, the divided images ordered according to the rearranged order. The above-described method also provides an advantage that is the same as or similar to that of the image processing system 100 according to the third modification.

In the image processing system 100 and the image processing method according to the second and third modifications, the privacy-protection image processing using the second intensity is blotting out or deleting the area to which the annotation is added. Thus, redundantly adding an annotation to a subject to which an annotation has been added after the first obscuring processing is suppressed during annotation addition processing on an image for annotation after the second obscuring processing.

In the image processing system 100 and the image processing method according to the embodiment and the modifications, the obscuring processing is mosaic processing, blurring processing, or pixelization processing. This makes it possible to easily change the intensity of the obscuring processing.

In the image processing system 100 and the image processing method according to the embodiment and the modifications, the divided images belonging to the privacy-protected images, that is, the pre-processing images, are randomly shuffled in the rearranging processing of the divided images. This makes it difficult to associate the divided images belonging to the same pre-processing image and also makes it difficult for the annotation processor to restore the pre-processing image. In addition, since the order of the divided images belonging to the same pre-processing image is rearranged so that the divided images are not continuous, it is more difficult to associate the divided images belonging to the same pre-processing image.

In the image processing system 100 and the image processing method according to the first modification, the divided images belonging to the same privacy-protected image, that is, to the pre-processing image, have a partly overlapping area. Thus, borders between the divided images can overlap each other. Hence, subjects in the vicinity of the borders can be easily and accurately identified, and the accuracy of annotation improves.

In the image processing system 100 and the image processing method according to the embodiment and the modification, before the obscuring processing that is image processing, character recognition is executed on pre-processing images, and deletion processing, which is privacy-protection image processing, is executed on recognized characters on the pre-processing images. Thus, separately performing the obscuring processing on characters, symbols and so on in a pre-processing image and the obscuring processing on subjects in the pre-processing image, the degree of clarity of the characters, symbols in a pre-processing image, and so on and the degree of clarity of the subjects being different from each other, makes it possible to execute obscuring processing corresponding to each target. As a result, the accuracy of adding annotations to subjects increases.

The above-described method may also be implemented by an MPU, a CPU, a processor, a circuit such as an LSI circuit, an IC card, a single independent module, or the like.

In addition, the processing in the embodiment and modifications may be realized by a software program or digital signals provided by a software program. For example, the processing in the embodiment can be realized by a program as described below.

That is, this program is a program to be executed by a computer and includes: generating a plurality of privacy-protected images by performing obscuring processing on each of a plurality of images; dividing each of the privacy-protected images into a plurality of areas to generate a plurality of divided images; ordering the divided images belonging to the same privacy-protected image so that the divided images form a continuous image; rearranging an order of the ordered divided images; and outputting, as images for annotation, the divided images ordered according to the rearranged order.

Also, the processing in the second modification is implemented by a program as described below.

That is, this program is a program to be executed by a computer and includes: generating a first privacy-protected image by performing first obscuring processing using a first intensity on an image; outputting the first privacy-protected image as an image for annotation; obtaining the first privacy-protected image to which an annotation is added; generating a second privacy-protected image by performing, on an area to which the annotation is added and that is included in the first privacy-protected image to which the annotation is added, deletion processing using a second intensity higher than or equal to the first intensity; generating a third privacy-protected image by deactivating, on the second privacy-protected image, the first obscuring processing and performing second obscuring processing using a third intensity lower than the first intensity; and outputting the third privacy-protected image as an image for annotation.

The above-described program and the digital signals provided by the program may be recorded on computer-readable recording media, for example, a flexible disk, a hard disk, a compact disc read-only memory (CD-ROM), a magneto-optical (MO) disk, a DVD, a DVD-ROM, a DVD-RAM, a Blu-ray® Disc (BD), and a semiconductor memory.

The above-described program and the digital signals provided by the program may be transmitted over a telecommunication channel, a wireless or wired communication channel, a network typified by the Internet, data broadcasting, or the like.

The above-described program and the digital signals provided by the program may be realized by another independent computer system through transportation of the recording medium on which the program and the digital signals are recorded or transfer thereof over the network or the like.

### OTHER MODIFICATIONS

The embodiment and the modifications have been described above as examples of the technology disclosed herein. The technology in the present disclosure, however, is not limited thereto, and can be applied to a modification of the embodiment or another embodiment obtained by making a change, replacement, addition, omission, or the like. Also, the constituent elements described in the embodiment and the modifications may be combined into a new embodiment or modification.

Although the image processing apparatus 10, the server apparatus 20, the annotation processing apparatus 30, and the annotation relaying apparatus 40 in the image processing system 100 according to the embodiment and the modifications are independent elements and are arranged apart from each other, the present disclosure is not limited thereto. For example, the image processing apparatus 10 and the annotation relaying apparatus 40 may constitute one apparatus. Alternatively, the server apparatus 20 and at least one of the image processing apparatus 10 and the annotation relaying apparatus 40 may constitute one apparatus. The annotation processing apparatus 30 and the annotation relaying apparatus 40 may constitute one apparatus.

Although the image processing system 100 according to the embodiment and the modifications has been used above in order to constitute a large amount of image data for learning in a neural network or the like of deep learning, the present disclosure is not limited thereto, and the image processing system 100 may be applied to any configuration for constructing image data.

General or specific aspects of the present disclosure may be implemented by a system, a method, an integrated circuit, a computer program, or a computer-readable recording medium, such as a CD-ROM. Also, general or specific aspects of the present disclosure may be implemented by any selective combination of a system, a method, an integrated circuit, a computer program, and a recording medium.

The embodiment and modifications have been described above as examples of the technology in the present disclosure. To this end, the accompanying drawings and the detailed description have been given. Thus, the constituent elements set forth in the accompanying drawings and the detailed description can not only include constituent elements essential for addressing the issue but also include constituent elements not essential for addressing the issue in order to illustrate the above-described technology. Thus, it should not be construed that such non-essential constituent elements being set forth in the accompanying drawings and the detailed description immediately certifies that the non-essential constituent elements are essential. In addition, the above-described embodiment and modifications are to exemplify the technology in the present disclosure, and thus various changes, replacements, additions, and omissions can be made within the scope of the present disclosure or a scope equivalent thereto.

The present disclosure is applicable to a technology for adding annotations to an image.

What is claimed is:

1. An image processing method comprising:
generating a plurality of privacy-protected images by performing privacy-protection image processing on each of a plurality of images;
dividing each of the privacy-protected images into a plurality of areas to generate a plurality of divided images and ordering the divided images belonging to the same privacy-protected image so that the divided images form a continuous image;
rearranging an order of the ordered divided images; and
outputting, as processed images for annotation, the divided images ordered according to the rearranged order.

2. The image processing method according to claim 1, further comprising:
obtaining, as first processed images, the processed images to which an annotation is added, after the outputting of the divided images;
performing, on an area that is included in the first processed images and to which the annotation is added, privacy-protection image processing using a second intensity higher than or equal to a first intensity of the privacy-protection image processing in the generating of the plurality of privacy-protected images;
performing, on the first processed images resulting from the privacy-protection image processing using the second intensity, privacy-protection image processing using a third intensity lower than the first intensity after deactivating the privacy-protection image processing using the first intensity; and
outputting, as second processed images for annotation, the first processed images resulting from the privacy protection image processing using the third intensity.

3. The image processing method according to claim 2,
wherein the privacy-protection image processing using the second intensity comprises blotting out or deleting the area to which the annotation is added.

4. The image processing method according to claim 2, further comprising:
obtaining a fourth intensity of privacy-protection image processing, based on the first intensity and the third intensity;
performing the privacy-protection image processing using the fourth intensity on an image that is included in the plurality of images and on which the privacy-protection image processing is not executed;
dividing the image resulting from the privacy-protection image processing using the fourth intensity into a plurality of areas to generate a plurality of divided images and ordering the divided images belonging to the same privacy-protected image so that the divided images form a continuous image;
rearranging an order of the ordered divided images; and
outputting, as processed images for annotation, the divided images ordered according to the rearranged order.

5. The image processing method according to claim 1,
wherein the privacy-protection image processing comprises mosaic processing, blurring processing, or pixelization processing.

6. The image processing method according to claim 1,
wherein, in the rearranging of the order, the divided images belonging to the privacy-protected images are randomly shuffled.

7. The image processing method according to claim 1,
wherein, in the rearranging of the order, the order is rearranged so that the divided images belonging to the same privacy-protected image are not continuous.

8. The image processing method according to claim 1,
wherein, in the ordering of the divided images, the divided images belonging to the same privacy-protected image have a partly overlapping area.

9. The image processing method according to claim 1, further comprising:
performing character recognition on each of the plurality of images, before the generating of the plurality of privacy-protected images; and
performing privacy-protection image processing on a recognized character.

10. An image processing method comprising:
generating a first privacy-protected image by performing privacy-protection image processing using a first intensity on an image;
outputting the first privacy-protected image as an image for annotation;
obtaining the first privacy-protected image to which an annotation is added, after the outputting of the first privacy-protected image;
generating a second privacy-protected image by performing, on an area to which the annotation is added and that is included in the first privacy-protected image to which the annotation is added, privacy-protection image processing using a second intensity higher than or equal to the first intensity;
generating a third privacy-protected image by performing, on the second privacy-protected image, privacy-protection image processing using a third intensity lower than the first intensity after deactivating the privacy-protection image processing using the first intensity; and
outputting the third privacy-protected image as an image for annotation.

11. An image processing system comprising:
an image converter that generates a privacy-protected image by performing privacy-protection image processing on an image;
an image divider that divides the privacy-protected image into a plurality of areas to generate a plurality of divided images and that orders the divided images forming the privacy-protected image; and
an image rearranger that rearranges an order of the ordered divided images and newly orders the divided images according to the rearranged order.

12. An image processing system comprising:
a first image converter that generates a first privacy-protected image by performing, on an image, privacy-protection image processing using a first intensity;
a first output that outputs the first privacy-protected image as an image for annotation;
a second image converter that generates a second privacy-protected image by performing, on an area to which an annotation is added and that is included in the first privacy-protected image to which the annotation is added, privacy-protection image processing using a second intensity higher than or equal to the first intensity;
a third image converter that generates a third privacy-protected image by deactivating the privacy-protection image processing on the second privacy-protected image, the privacy-protection image processing being performed by the first image converter, and performing privacy-protection image processing using a third intensity lower than the first intensity; and
a second output that outputs the third privacy-protected image as an image for annotation.

13. A non-transitory computer-readable recording medium having stored therein a program causing a computer to execute a method when the program is executed by the computer, the method including:
generating a plurality of privacy-protected images by performing privacy-protection image processing on each of a plurality of images;
dividing each of the privacy-protected images into a plurality of areas to generate a plurality of divided images;
ordering the divided images belonging to the same privacy-protected image so that the divided images form a continuous image;
rearranging an order of the ordered divided images; and
outputting, as images for annotation, the divided images ordered according to the rearranged order.

14. A non-transitory computer-readable recording medium having stored therein a program causing a computer to execute a method when the program is executed by the computer, the method including:
generating a first privacy-protected image by performing privacy-protection image processing using a first intensity on an image;
outputting the first privacy-protected image as an image for annotation;
obtaining the first privacy-protected image to which an annotation is added;
generating a second privacy-protected image by performing, on an area to which the annotation is added and that is included in the first privacy-protected image to which the annotation is added, privacy-protection image processing using a second intensity higher than or equal to the first intensity;
generating a third privacy-protected image by deactivating, on the second privacy-protected image, the privacy-protection image processing performed during the generation of the first privacy-protected image and performing privacy-protection image processing using a third intensity lower than the first intensity; and
outputting the third privacy-protected image as an image for annotation.
